(19) United States
(12) Patent Application Publication
(10) Pub. No.: US 2026/0264221 A1
(43) Pub. Date: Sep. 10, 2026

(54) METHOD AND APPARATUS FOR TARGET TUNING OF ROBOT

(71) Applicant: ABB SCHWEIZ AG, Baden (CH)

(72) Inventors: Xinyu Fang, Shanghai (CN); Ye Tian, Shanghai (CN); Qizhen Lv, Shanghai (CN)

(21) Appl. No.: 19/658,213

(22) Filed: Apr. 24, 2026

Related U.S. Application Data
(63) Continuation of application No. PCT/CN2023/126831, filed on Oct. 26, 2023.

(51) Int. Cl. B25J 9/00; B25J 9/16

(52) U.S. Cl. CPC B25J 9/0081; B25J 9/1697

(57) ABSTRACT

Embodiments of the present disclosure relate to a method for target tuning of a robot including aligning an orientation of a hand-held tool with an orientation of a robot-held tool of the robot; and target tuning of a robot for at least one target point to be reached by the robot after the alignment, including, for each target point, enabling the robot-held tool to follow the motion of the hand-held tool until the robot-held tool reaches a desired pose, based on pose information of the hand-held tool obtained by a tracking device attached to the hand-held tool; and saving the desired pose for the robot.

### FIELD OF THE INVENTION

This invention generally relates to a robot, and particularly to a method and an apparatus for target tuning of a robot.

### BACKGROUND OF THE INVENTION

In an industrial robot application, the robotic target tuning on site is a key process. In general, the user uses a TPU (Teach Pendant Unit) to do the tuning task.

For example, during a robot programming process, before the codes are run by a processor associated with the robot to enable the movement of the robot-held tool, some key points (referred to as “target poses” or “targets”) for the robot-held tool may need to be manually fine-tuned. Normally the user will operate the TPU to do the tuning task.

### SUMMARY OF THE INVENTION

The invention is defined by the claims.

According to one aspect of the disclosure, there is provided a method for target tuning of a robot comprising: aligning an orientation of a hand-held tool with an orientation of a robot-held tool of the robot; and target tuning of the robot for at least one target point to be reached by the robot after the alignment, comprising: for each target point, enabling the robot-held tool to follow the motion of the hand-held tool until the robot-held tool reaches a desired pose, based on pose information of the hand-held tool obtained by a tracking device attached to the hand-held tool; and saving the desired pose for the robot.

With the above method, the target tuning for a robot may be more intuitive and easier.

In some embodiments, the aligning an orientation of a hand-held tool with an orientation of the robot-held tool of the robot comprises: calculating a difference between the orientation of the hand-held tool and the orientation of the robot-held tool; and outputting, based on said difference, an orientation adjustment information for the orientation of the hand-held tool such that the orientation of the hand-held tool can be adjusted to realize the alignment.

In some embodiments the aligning an orientation of a hand-held tool with an orientation of the robot-held tool of the robot further comprises: saving an aligned pose of the hand-held tool after determination that the orientation of the hand-held tool is aligned with the orientation of the robot-held tool.

In some embodiments, the outputting an orientation adjustment information for the orientation of the hand-held tool comprises: outputting the orientation adjustment information to guide a user holding the hand-held tool to perform an orientation adjustment of the hand-held tool.

In some embodiments, the orientation adjustment information is output as any of a visual signal, an audible signal or a vibration signal.

In some embodiments, the enabling the robot-held tool to follow the motion of the hand-held tool until the robot-held tool reaches a desired pose comprises: obtaining, by the tracking device, a hand-held tool pose change signal of the hand-held tool while the hand-held tool is moving, the hand-held tool pose change signal indicative of an amount of pose change of the hand-held tool relative to an aligned pose of the hand-held tool obtained during the alignment; calculating, based on the hand-held tool pose change signal, an updated robot-held tool pose for the robot-held tool; and enabling, based on the updated robot-held tool pose, the robot-held tool to follow the motion of the hand-held tool.

In some embodiments, the enabling, based on the updated robot-held tool pose, the robot-held tool to follow the motion of the hand-held tool until the robot-held tool reaches a desired pose comprises: scaling down a translation deviation for the robot-held tool as compared to that for the hand-held tool, and keeping an orientation deviation for the robot-held tool the same as that for the hand-held tool.

In some embodiments, a tool base or a tool center point (TCP) of the robot-held tool is used for calculating the updated robot-held tool pose.

In some embodiments, the step of aligning an orientation of the hand-held tool with an orientation of the robot-held tool is performed in response to the tracking device entering an orientation alignment mode, which is activated by a user interaction with the tracking device.

In some embodiments, the step of target tuning of the robot for at least one target point to be reached by the robot after the alignment is performed in response to the tracking device entering a target tuning mode, which is activated by another user interaction with the tracking device.

In some embodiments, the method further comprises: calibrating the tracking device's pose relative to the hand-held tool pose, prior to the enabling the robot-held tool to follow the motion of the hand-held tool.

In some embodiments, the method further comprises: updating the codes to be used by the robot with said at least one target point based on the saved pose, after the target tuning.

In some embodiments, the tracking device is equipped with an image capturing device configured to capture at least one image of the robot-held tool.

According to another aspect of the disclosure, there is provided an apparatus for target tuning of a robot-held tool comprising: a processor configured to perform the method as stated above.

In some embodiments, the apparatus is a teaching device for the robot-held tool comprising the tracking device and the hand-held tool.

According to yet another aspect of the disclosure, there is provided a computer readable medium having a computer program stored thereon which, when executed by a processor, implements the method as stated above.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1 illustrates a schematic diagram of a scenario of using a robot-held tool to process a work piece according to one embodiment of the present disclosure;

FIG. 2 illustrates a flowchart of a method for robotic target tuning according to one embodiment of the present disclosure;

FIG. 3 illustrates a schematic diagram of aligning an orientation of a hand-held tool with an orientation of a robot-held tool according to one embodiment of the present disclosure;

FIG. 4 illustrates a schematic diagram of target tuning of a robot for at least one target point to be reached by the robot after the alignment according to one embodiment of the present disclosure; and

FIG. 5 illustrates a schematic diagram of an apparatus for performing the method for target tuning of a robot according to one embodiment of the present disclosure.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “comprises” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

As described above, a TPU (Teach Pendant Unit) is generally used to do the tuning task. However, it is found that for performing such a tuning task with the TPU, the user is generally required to select a related tool, a related work object, a related coordinate system, a related motion mode (linear motion or joint motion), etc. through a user interface (UI). In such cases, the user should know the different relationship among the different coordinate systems. Obviously, it is not intuitive and might cause confusion. Meanwhile, due to the limitation of the TPU, users have to jog the robot in position or orientation coordinate system at a time, which requires the users to switch the position's UI or the orientation's UI back and forth. Mishandling is not avoidable and sometimes might lead to incorrect move of the robot-held tool. Therefore, it might need high knowledge and skill threshold to do the target tuning task and might be dealt with high patience.

In order to reduce the effort for robotic target tuning on site, lower the skill threshold for a user and reduce the risk of mishandling, an improved method for robotic target tuning is proposed, comprising: aligning an orientation of a hand-held tool with an orientation of a robot-held tool of the robot; and target tuning of a robot for at least one target point to be reached by the robot after the alignment, comprising: for each target point, enabling the robot-held tool to follow the motion of the hand-held tool until the robot-held tool reaches a desired pose, based on pose information of the hand-held tool obtained by a tracking device attached to the hand-held tool; and saving the desired pose for the robot. Those skilled in the art will appreciate that the disclosed method will make the target tuning for the robot more intuitive and easier.

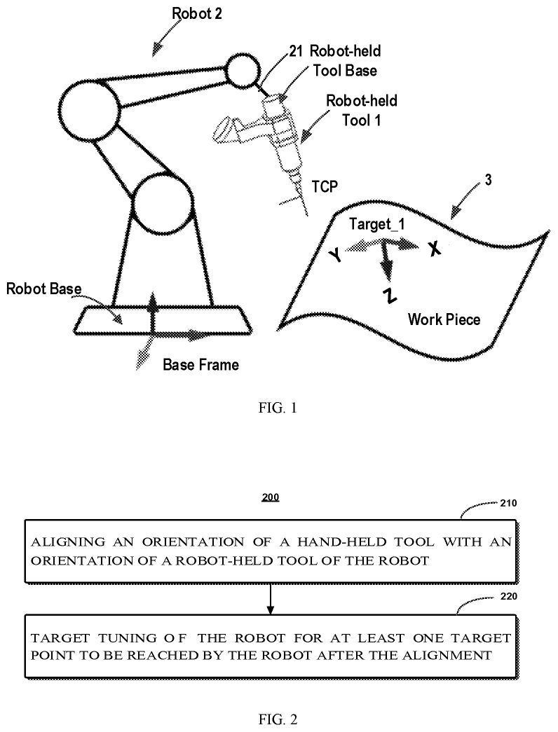

For better understanding of the concept of the present disclosure, FIG. 1 illustrates a schematic diagram of an application scenario of using a robot-held tool to process a work piece according to one embodiment of the present disclosure.

As illustrated in FIG. 1, a robot-held tool 1 is mounted on an end effector 21 of a robot 2 and for processing a surface of a work piece 3. Generally, the robot 2 may be an industrial robot. As an example, the robot may be one having multiple arms with multiple degrees of freedom, e.g., a two-arm robot with 6 degrees of freedom. In some embodiments, a controller or processor may be associated with or integrated with the robot 2, such that the end effector 21 as well as the robot-held tool 1 mounted thereon may be guided to a desired position or moved along a planned path.

Typically, the work piece 3 may have a surface of any shape to be processed, including e.g., a planar or curved surface. Prior to the processing of the work piece, as mentioned above, it might be necessary to firstly tune the robot to a desired pose (including orientation and position) for at least one point (which hereinafter may be referred to as a target point) on the work piece 3, e.g., Target_1, so as to realize the target tuning. Once a desired pose for a target point is reached, it can be saved and used to update the codes to be run by the robot to process the work piece in a normal process mode, in which the robot-held tool might be controlled or moved along e.g., a planned path to process the work piece. It is noted herein that although the target point is illustrated above as relating to the work piece, the target point should not be so limited. In the present disclosure, the target point may include any point to be reached by the robot, including but not limited to e.g., a point on a planned path or a point on a work piece.

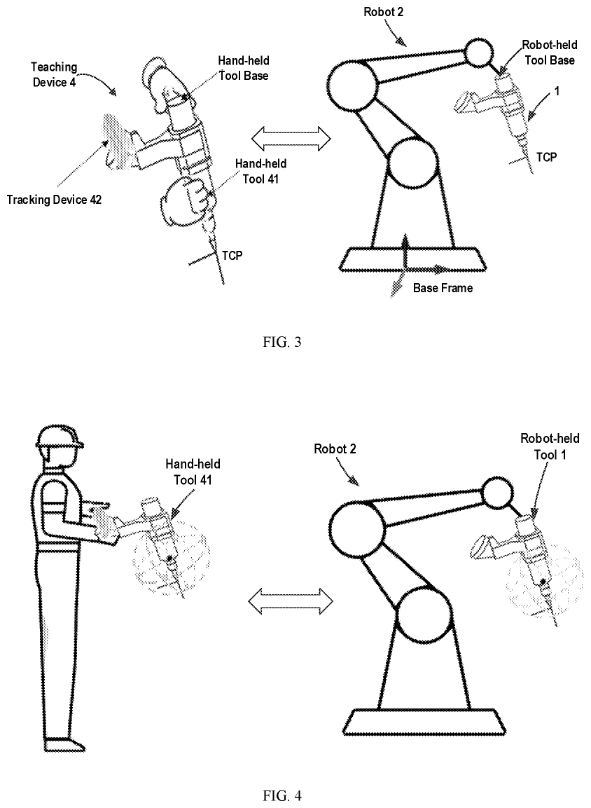

The present disclosure is aiming at an improved method for target tuning of a robot for at least one target point to be reached by the robot. For ease of understanding, FIG. 2 illustrates a flowchart of the method for the target tuning of a robot according to one embodiment of the present disclosure, FIG. 3 illustrates a schematic diagram of aligning an orientation of the hand-held tool with an orientation of the robot-held tool according to one embodiment of the present disclosure; and FIG. 4 illustrates a schematic diagram of target tuning of a robot for at least one target point to be reached by the robot after the alignment according to one embodiment of the present disclosure.

As illustrated in FIG. 2, the method 200 may start at block 210, i.e., aligning an orientation of a hand-held tool with an orientation of a robot-held tool of the robot.

Herein it is noted that in the present disclose, a hand-held tool 41 is provided. In some embodiments the hand-held tool 41 may be the same as the robot-held tool 1, and in some other embodiments the hand-held tool 41 similar to the robot-held tool is also possible. As will be further explained below, the hand-held tool 41 will be useful for assisting in the target tuning of the robot.

In some embodiments, this step of aligning may be a totally manual process. For example, a user holding the the hand-held tool 41 may observe if the orientation of the hand-held tool 41 is aligned with the orientation of the robot-held tool 1, and if not, the user may then adjust the orientation of the hand-held tool 41 until it is aligned with the orientation of the robot-held tool 1.

In some embodiments, this step of aligning may be realized by a tracking device attached to the hand-held tool. Just as an example, the attachment of the tracking device 42 to the hand-held tool 41 is shown in FIG. 3. In some cases, the tracking device 42 in combination with the hand-held tool 41 may be referred to as a teaching device 4 for the robot-held tool 1. As will be further explained below, said teaching device 4 may be used to not only align an orientation of the hand-held tool with an orientation of the robot-held tool, but also enable the robot-held tool to follow the motion of the hand-held tool after the alignment, so as to implement the target tuning.

Particularly, in some embodiments, the tracking device 42 may be configured to capture at least one image of the robot-held tool 1, which image may then be used to determine the orientation of the robot-held tool 1, and/or configured to track the pose or motion (e.g., orientation and/or position) of the hand-held tool 41, which may be used to assist in the target tuning. Typically, in some embodiments, the tracking device 42 may be equipped with an image capturing device (e.g., a camera) for capturing said at least one image and an Inertial Measurement Unit (IMU) for tracking said pose or motion of the hand-held tool 41. The captured image(s) and/or tracked pose/motion signal may be recorded and transmitted to a processor or controller for further processing, which may be located within said tracking device or said teaching device 4 or at a distance from the teaching device 4.

Herein it is noted that in some embodiments, the above step of obtaining may be performed in an orientation alignment mode, which may be activated by a user interaction with the tracking device, e.g., by pressing a first button disposed on the tracking device.

During such an orientation alignment mode, the orientation of the robot-held tool may be obtained in any possible way. In a particular embodiment, the orientation of the robot-held tool may be determined based on the at least one image obtained by the tracking device. Also, the orientation of the hand-held tool will be obtained, e.g., by the tracking device. Further, the comparison between the orientation of the hand-held tool and the orientation of the hand-held tool will be implemented. With the above comparison, one or more feedback signals may then be output from the tracking device to guide the user to adjust the orientation of the hand-held tool, until the orientation of the hand-held tool is aligned with the orientation of the robot-held tool. In case the orientations are aligned, an acknowledgement signal may be triggered to inform the user.

Therefore, to align the orientation of the hand-held tool with the orientation of the robot-held tool, in some embodiments the block 210 may comprise: —calculating a difference between the orientation of the hand-held tool and the orientation of the robot-held tool; and—outputting, based on said difference, an orientation adjustment information for the orientation of the hand-held tool such that the orientation of the hand-held tool can be adjusted to realize the alignment.

Particularly, in some embodiments, the determination of the orientation of the robot-held tool may be performed by establishing a model or algorithm using said at least one image as an input. Such a model or algorithm is already known in the art and thus the detailed description thereof is omitted.

In some embodiments, the outputting an orientation adjustment information for the orientation of the hand-held tool may comprise: —outputting the orientation adjustment information to guide a user holding the hand-held tool to perform an orientation adjustment of the hand-held tool.

Particularly, in some embodiments, the orientation adjustment information may be output as any of a visual signal, an audible signal or a vibration signal. Those skilled in the art would appreciate that such orientation adjustment information may then be used as a feedback signal for the user holding the hand-held tool to manually adjust the orientation of the hand-held tool. Such a manually adjustment is intuitive.

It should be understood that in block 210, the step of calculating a difference between the orientation of the hand-held tool and the orientation of the robot-held tool and the step of outputting an orientation adjustment information for the orientation of the hand-held tool can be implemented repeatedly until that the orientation of the hand-held tool is aligned with the orientation of the robot-held tool.

In some embodiments, the block 210 may further comprise: saving an aligned pose of the hand-held tool after determination that the orientation of the hand-held tool is aligned with the orientation of the robot-held tool. As will be further explained below, the saved aligned pose of the hand-held tool may be used thereafter as a reference pose for determining a hand-held tool pose change signal.

Once the orientation of the hand-held tool is aligned with the orientation of the robot-held tool, an acknowledgement signal may be triggered to inform the user and the method 200 may proceed to block 220, i.e., target tuning of the robot for at least one target point to be reached by the robot after the alignment.

To be more specific, this step of target tuning may comprise: for each target point, enabling the robot-held tool to follow the motion of the hand-held tool until the robot-held tool reaches a desired pose, based on pose information of the hand-held tool obtained by a tracking device attached to the hand-held tool; and saving the desired pose for the robot.

Those skilled in the art would appreciate that this step of target tuning of the robot after the alignment would assist the robot to achieve a desired pose for at least one target point to be reached by the robot, prior to the normal process mode. Generally, the step of target tuning of the robot after the alignment would be performed in a target tuning mode, which in some embodiments may be activated by another user interaction with the tracking device, e.g., pressing a second button disposed on the tracking device.

For example, in practice, after the alignment in block 210 a user may activate the target tuning mode by pressing a second button disposed on the tracking device, in which the user may then move the hand-held tool and as a response, the robot will move its robot-held tool to follow the motion of the hand-held tool until the robot-held tool reaches a desired pose for a target point, as can be seen in FIG. 3. To be more detail, during the target tuning mode, the user may observe whether the final pose of the robot-held tool reaches a desired pose and if so, the user may then trigger an acknowledgement signal to record or save the desired pose for the target point (e.g., Target_1 in FIG. 1). In some cases, if there are more than one target points to be target tuned, the target tuning may be implemented one-by-one for all target points, until all these target points are target tuned. The desired pose of the robot for each target point may be saved and used to update the codes to be used by the robot to process e.g., the work piece in a normal process mode.

To enable the robot-held tool to follow the motion of the hand-held tool until the robot-held tool reaches a desired pose, in some embodiments, the block 220 may comprise: —obtaining, by the tracking device, a hand-held tool pose change signal of the hand-held tool while the hand-held tool is moving, the hand-held tool pose change signal indicative of an amount of pose change of the hand-held tool relative to an aligned pose of the hand-held tool obtained during the alignment; —calculating, based on the hand-held tool pose change signal, an updated robot-held tool pose for the robot-held tool; and—enabling, based on the updated robot-held tool pose, the robot-held tool to follow the motion of the hand-held tool.

To facilitate the understanding of the step of calculating an updated robot-held tool pose for the robot-held tool, the following calculation example is provided.

Firstly, we assume that the updated robot-held tool pose may be expressed as

$${T}_{{R}_{robotbase}}^{{R}_{toolbase \_ newpose}} ,$$

i.e., the tool base's new pose of the robot-held tool relative to the robot base of the robot. Further, the updated robot-held tool pose may be calculated as below.

$${T}_{{R}_{robotbase}}^{{R}_{toolbase \_ newpose}} = {T}_{{R}_{robotbase}}^{{R}_{toolbase \_ alignedpose}} * {T}_{{R}_{toolbase \_ alignedpose}}^{{R}_{toolbase \_ newpose}} \qquad ( 1 )$$

wherein

$${T}_{{R}_{robotbase}}^{{R}_{toolbase \_ alignedpose}}$$

indicates the tool base's aligned pose of the robot-held tool relative to the robot base of the robot and can be obtained after the alignment, and

$${T}_{{R}_{toolbase \_ alignedpose}}^{{R}_{toolbase \_ newpose}}$$

indicates a tool base's new pose of the robot-held tool relative to a tool base's aligned pose of the robot-held tool and represents a robot-held tool pose change signal.

As the robot-held tool will be enabled to follow the motion of the hand-held tool, this implies a relation between the robot-held tool's tool base and the hand-held tool's tool base as below.

$${T}_{{R}_{toolbase \_ alignedpose}}^{{R}_{toolbase \_ newpose}} = {T}_{{H}_{toolbase \_ alignedpose}}^{{H}_{toolbase \_ newpose}} \qquad ( 2 )$$

wherein

$${T}_{{H}_{toolbase \_ alignedpose}}^{{H}_{toolbase \_ newpose}}$$

indicates the tool base's new pose of the hand-held tool relative to the tool base's aligned pose of the hand-held tool. Those skilled in the art would appreciate that

$${T}_{{H}_{toolbase \_ alignedpose}}^{{H}_{toolbase \_ newpose}}$$

indicates a tool base's new pose of the hand-held tool relative to an aligned tool base's pose of the hand-held tool and can thus be used to represent a hand-held tool pose change signal.

Further, there is a known relation H between the tracking device's pose change and the hand-held tool's pose change as below.

$${T}_{{H}_{toolbase \_ alignedpose}}^{{H}_{toolbase \_ newpose}} = H * {T}_{Device \_ alignedpose}^{Device \_ newpose} \qquad ( 3 )$$

wherein

$${T}_{Device \_ alignedpose}^{Device \_ newpose}$$

indicates a tracking device's pose change and can be represented by a tracking device's new pose relative to a tracking device's aligned pose after the alignment.

Then, in accordance with the above equations (2) and (3), equation (1) can be transformed as:

$${T}_{{R}_{robotbase}}^{{R}_{toolbase \_ newpose}} = {T}_{{R}_{robotbase}}^{{R}_{toolbase \_ alignedpose}} * {T}_{{H}_{toolbase \_ alignedpose}}^{{H}_{toolbase \_ newpose}} = {T}_{{R}_{robotbase}}^{{R}_{toolbase \_ alignedpose}} * H * {T}_{Device \_ alignedpose}^{Device \_ newpose} \qquad ( 4 )$$

Therefore, the updated robot-held tool pose

$$( e . g . , {T}_{{R}_{robotbase}}^{{R}_{toolbase \_ newpose}} )$$

for the robot-held tool can be calculated based on the hand-held tool pose change signal

$$( e . g . , {T}_{{H}_{toolbase \_ alignedpose}}^{{H}_{toolbase \_ newpose}} )$$

or the tracking device's pose change signal

$$( e . g . , {T}_{Device \_ alignedpose}^{Device \_ newpose} ) .$$

It is noted that prior to the enabling the robot-held tool to follow the motion of the hand-held tool until the robot-held tool reaches a desired pose, the calibrating the tracking device's pose relative to the hand-held tool pose may be performed beforehand, which may help to improve the accuracy for calculating the tracking device's pose change signal

$$( e . g . , {T}_{Device \_ alignedpose}^{Device \_ newpose} )$$

or the hand-held tool pose change signal

$$( e . g . , {T}_{{H}_{toolbase \_ alignedpose}}^{{H}_{toolbase \_ newpose}} ) .$$

It is further noted that in the above calculation example, the tool base's pose of the robot-held tool is used to represent the updated robot-held tool pose. However, this is not a limitation and in some other embodiments, other reference point's pose of the robot-held tool can also be used to represent the updated robot-held tool pose. In this event, said reference point can be any point on the robot-held tool other than the tool base.

For example, in some cases, the Tool Center Point (TCP) can be selected as a reference point and the updated TCP's pose of the robot-held tool can be used to represent the updated robot-held tool pose. In this event, the updated TCP's pose will have the following relation with the updated tool base's pose of the robot-held robot.

$${T}_{{R}_{robotbase}}^{TCP \_ newpose} = {T}_{{R}_{robotbase}}^{{R}_{toolbase \_ newpose}} * {T}_{toolbase}^{TCP} \qquad ( 5 )$$

wherein

$${T}_{toolbase}^{TCP}$$

indicates a relation between the TCP and the tool base of the robot-held tool.

With the above obtained updated robot-held tool pose

$$( e . g . , {T}_{{R}_{robotbase}}^{{R}_{toolbase \_ newpose}} or {T}_{{R}_{robotbase}}^{TCP \_ newpose} ) ,$$

the robot-held tool can thus be enabled to follow the motion of hand-held tool.

For safety purposes, in some embodiments it might be better to scale down a translation deviation for the robot-held tool as compared to that for the hand-held tool, while keep an orientation deviation for the robot-held tool the same as that for the hand-held tool. However, in some other embodiments, scaling up a translation deviation for the robot-held tool as compared to that for the hand-held tool while keeping the orientation deviation for the robot-held tool the same as that for the hand-held tool is also possible.

Once the target tuning of the robot is finished for all target points (e.g., on the work piece 3) to be reached by the robot, the saved desired poses may be used to update the codes for processing e.g., the work piece 3. Thereafter, the updated codes may be run by the processor or controller associated with the robot, so as to enable the robot to implement a normal process mode.

Through the above description, those skilled in the art would appreciate that with the above method for target tuning of a robot, the effort for target tuning or pose tuning can be reduced as compared to a conventional target tuning method. In addition, the risk for mishandling of target tuning can also be reduced. In the meantime, the accuracy of processing the surface of the work piece 3 can also be improved.

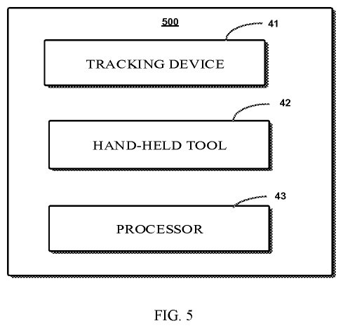

Those skilled in the art would also appreciate that the method for target tuning of a robot may be performed by an apparatus 500 as shown in FIG. 5, which comprises the tracking device 41, the hand-held tool 42 and a processor or controller 43. Especially, the processor or controller 43 is configured to implement the calculation as stated above.

In particular, the apparatus 500 may constitute a teaching device 4 for the robot-held tool. In some embodiments, the processor or controller 43 may be located within the tracking device 41 or the hand-held tool 42 and/or the tracking device 41 may be attached or integrated with the hand-held tool 42, which may help to realize a compact teaching device for the robot-held tool. However, this is not necessary, in some other embodiments, it is also possible to position the processor 43 at a distance from the tracking device 41 or the hand-held tool 42, e.g., within a smart device or an Industrial Personal Computer (IPC).

In addition, the present disclosure may also relate to a computer readable medium having a computer program stored thereon which, when executed by a processor, may implement the method as stated above.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for target tuning of a robot comprising:
aligning an orientation of a hand-held tool with an orientation of a robot-held tool of the robot; and
target tuning of the robot for at least one target point to be reached by the robot after the alignment, comprising: for each target point,
enabling the robot-held tool to follow the motion of the hand-held tool until the robot-held tool reaches a desired pose, based on pose information of the hand-held tool obtained by a tracking device attached to the hand-held tool; and
saving the desired pose for the robot.

2. The method of claim 1, wherein the aligning an orientation of a hand-held tool with an orientation of the robot-held tool of the robot comprises:
calculating a difference between the orientation of the hand-held tool and the orientation of the robot-held tool; and
outputting, based on the difference, an orientation adjustment information for the orientation of the hand-held tool such that the orientation of the hand-held tool can be adjusted to realize the alignment.

3. The method of claim 2, wherein the aligning an orientation of a hand-held tool with an orientation of the robot-held tool of the robot further comprises:
saving an aligned pose of the hand-held tool after determination that the orientation of the hand-held tool is aligned with the orientation of the robot-held tool.

4. The method of claim 2, wherein the outputting an orientation adjustment information for the orientation of the hand-held tool comprises:
outputting the orientation adjustment information to guide a user holding the hand-held tool to perform an orientation adjustment of the hand-held tool.

5. The method of claim 4, wherein the orientation adjustment information is output as any of a visual signal, an audible signal or a vibration signal.

6. The method of claim 1, wherein the enabling the robot-held tool to follow the motion of the hand-held tool until the robot-held tool reaches a desired pose comprises:
obtaining, by the tracking device, a hand-held tool pose change signal of the hand-held tool while the hand-held tool is moving, the hand-held tool pose change signal indicative of an amount of pose change of the hand-held tool relative to an aligned pose of the hand-held tool obtained during the alignment;
calculating, based on the hand-held tool pose change signal, an updated robot-held tool pose for the robot-held tool; and
enabling, based on the updated robot-held tool pose, the robot-held tool to follow the motion of the hand-held tool.

7. The method of claim 6, wherein the enabling, based on the updated robot-held tool pose, the robot-held tool to follow the motion of the hand-held tool until the robot-held tool reaches a desired pose comprises:
scaling down a translation deviation for the robot-held tool as compared to that for the hand-held tool; and
keeping an orientation deviation for the robot-held tool the same as that for the hand-held tool.

8. The method of claim 6, wherein a tool base or a tool center point (TCP) of the robot-held tool is used for calculating the updated robot-held tool pose.

9. The method of claim 1, wherein the step of aligning an orientation of the hand-held tool with an orientation of the robot-held tool is performed in response to the tracking device entering an orientation alignment mode, which is activated by a user interaction with the tracking device.

10. The method of claim 1, wherein the step of target tuning of the robot for at least one target point to be reached by the robot after the alignment is performed in response to the tracking device entering a target tuning mode, which is activated by another user interaction with the tracking device.

11. The method of claim 1, the method further comprising:
calibrating the tracking device's pose relative to the hand-held tool pose, prior to the enabling the robot-held tool to follow the motion of the hand-held tool.

12. The method of claim 1, the method further comprising:
updating the codes to be used by the robot with said at least one target point based on the saved pose, after the target tuning.

13. The method of claim 1, wherein
the tracking device is equipped with an image capturing device configured to capture at least one image of the robot-held tool.

14. An apparatus for target tuning of a robot comprising:
a processor configured to perform the method of claim 1.

15. The apparatus of claim 14, wherein the apparatus is a teaching device for the robot-held tool comprising the tracking device and the hand-held tool.

16. A computer readable medium having a computer program stored thereon which, when executed by a processor, implements the method of claim 1.
